(19) United States
(12) Patent Application Publication
(10) Pub. No.: US 2014/0310109 A1
(43) Pub. Date: Oct. 16, 2014

(54) Live And Interactive Auction Utilizing A Social Media Platform

(71) Applicant: Dov E. King, New City, NY (US)

(72) Inventor: Dov E. King, New City, NY (US)

(21) Appl. No.: 14/251,438

(22) Filed: Apr. 11, 2014

Related U.S. Application Data
(60) Provisional application No. 61/811,073, filed on Apr. 11, 2013.

(51) Int. Cl. G06Q 50/00; G06Q 30/08

(52) U.S. Cl. CPC G06Q 50/01; G06Q 30/08
USPC 705/14.73

(57) ABSTRACT

A system for conducting auctions in a social media platform includes an auction server adapted to be connected to a social media server, the auction server generating and transmitting an auction announcement to the social media server for advertising to potential buyers, the announcement providing a start time and an end time of an auction, the auction server transmitting an auction item post to the media server for publication to the potential buyers at the start time, the auction server retrieving from the media server keywords posted by the potential buyers in the social media platform, wherein the keywords represent a buyer's purchase. The auction server detects the purchase of product by a buyer and transmits a purchase confirmation to the buyer. The auction further server analyzes the keywords to update the status of the auction and accordingly adjusts the auction item post in real-time.

### FIELD OF THE INVENTION

The present invention relates to internet-based auctions and, more particularly, to a live and interactive auction utilizing a social media platform, such as Facebook, or the like, where pictures, price, quantity and acknowledgement are manipulated.

### BACKGROUND OF THE INVENTION

Auctions are a terrific means of commerce, however, physically attending auctions are not always convenient for prospective buyers. Auction sites are few and far between in most states and are not easily accessible for the average working person. The tedious task of moving cumbersome merchandise as well as the risk of carrying large amounts of currency are daunting.

Other companies, who claim to hold auction hours on their Facebook page, are truly an e-commerce retail venue. There are no price adjustments, real time acknowledgments or instantaneous quantity reductions. Such other Facebook pages are merely an extension of their retail business and misleading the consumer.

Consumers do not like to be misled. These other systems claim to be auction sites and clearly are not. There is no difference between their online e-commerce website and their Facebook “auction” page.

Accordingly, there is a need for a system that allows a consumer to shop and participate in a fun and competitive nature in real time on a social media site, such as Facebook.

### SUMMARY OF THE INVENTION

The present invention provides an auctioning system for conducting online auctions through and within one or more social media platforms.

It is an object to provide a system for generating, advertising and processing online auctions through one or more social media platforms.

It is also an object to provide a method for generating, advertising and processing online auctions through one or more social media platforms.

These and other objectives are achieved by providing a system for conducting online auctions in one or more social media platforms, the system having an auction server, embodied in computer hardware, with a network connection adapted to connect to at least one social media server of a social media platform. The auction server includes a processor, embodied in computer hardware, which generates, advertises and processes at least one auction for an item. The auction server generates and transmits an auction announcement to the social media server for advertising to potential buyers. The auction announcement provides a start time for when the auction begins and an end time for when the auction ends. The auction server transmits an auction item post to the social media server for publication to the potential buyers at the start time. During the auction, the auction server retrieves from the social media server user comments or keywords posted by the potential buyers on the social media platform, wherein the user comments or keywords represent a buyer's purchase and/or interest in purchasing. The auction server detects a purchase of product by a buyer amount the potential buyers based on the buyer's comments or keywords. Upon detecting the purchase, the auction server transmits a purchase confirmation to the buyer. For example, the auction server generates and sends an invoice to the buyer. Additionally, the processor of the auction server analyzes the user comments and keywords to update status of the auction and immediately adjust the auction item post.

Further objectives of the present invention are achieved by providing a method for conducting online auctioning through one or more social media platforms, the method including the following steps: providing an auction server for generating, advertising and processing at least one auction; generating and transmitting an auction announcement to at least one social media server of the social media platform for advertising to potential buyers, the auction announcement providing a start time for when the auction begins and an end time for when the auction ends; generating and transmitting an auction item post to the social media server for publication to the potential buyers at the designated start time; receiving user comments by the potential buyers from the social media server, the user comments representing buyer's purchase and/or interest in purchasing; processing the user comments to detect a purchase of product by a buyer among the potential buyers; and sending an acknowledgement to the buyer, wherein the acknowledgment confirms buyer's purchase; and updating in real time a status of the auction item post using the user comments. The acknowledgement step further includes the auction server generating and sending an invoice to the buyer.

Other features and aspects of the invention will become apparent from the following detailed description, taken in conjunction with the accompanying drawings, which illustrate by way of example, the features in accordance with embodiments of the invention. The summary is not intended to limit the scope of the invention, which is defined solely by the claims attached thereto.

### BRIEF DESCRIPTION OF THE DRAWINGS

FIG. 1 is a schematic view of the online auctioning system according to an exemplary embodiment of the present invention.

FIGS. 2A-2E are annotated diagrams of representative electronic displays according to FIG. 1.

FIG. 3 is a flow diagram for a method of online auctioning according to the system of FIG. 1.

### DETAILED DESCRIPTION OF THE INVENTION

The following detailed description is of the best currently contemplated modes of carrying out exemplary embodiments of the invention. The description is not to be taken in a limiting sense, but is made merely for the purpose of illustrating the general principles of the invention, since the scope of the invention is best defined by the appended claims.

Broadly, an embodiment of the present invention provides a unique method for running an Auction of goods for sale in an interactive online community that provides subscription based notification to Friends subscribed to a user's page and the ability of those Friends and the Owner of the Page to interact dynamically in real-time. By using social media platforms, such as Facebook, Yahoo, Instagram, Twitter, Google+ or the like, as a forum for live virtual auctions takes the convenience of shopping from home to a whole other level. On the seller's social media site wall, for example, a customer can view a product and its description, compete on a first come, first serve basis on limited quantities and interact live with the seller and other competing buyers. Items are purchased, billed, processed and shipped without the customer ever leaving their computer.

No other “auction” page on any social medium provides this live interaction between seller and buyer instantaneously on the social media site wall, for example, nor do they acknowledge the chronological order in which the “bidders/buyers” come in. The quantities of the stock adjust in real time as the bids are acknowledged making this a real auction atmosphere. Price reductions during auction hours make the bidder/buyer feel as if they are truly in a competitive auction environment.

With the system of the present invention, there is no duping the customer into thinking they are participating in an auction, as they will be participating in a true virtual live auction. The present invention is set out to satisfy a customer's desire to shop conveniently yet competitively.

To facilitate auction style sales in popular social media sites (e.g., Facebook, Google+, or the like) via a user's electronic store front/status feed or wall (hereafter referred to as “the Site”), limited time opportunities, or “Beat the Clock”, auctions are announced on the Site's status or “wall post”. The process of posting is a manual or automatic process that implements the social media site's Application Programming Interface or API. The proprietary implementation of the API and the processes that assist in posting and automation of the sales/invoice will be henceforth be called the “Software”. Users of the Software to sell their inventory of wares (“Sellers”) are members of the Sites, and have an established presence there, such as wall or status feeds, access to post photos, user credentials, and overall access to public and private use areas of the Site.

The announcement of the Beat the Clock, which is a description of when and how to participate in the auction, is posted on the seller's Wall page and/or the seller's website.

If the language is posted on the Seller's private website, the Software will post a link, destination URL, and/or tab which enables the buyer to participate in the auction on the Seller's Site wall page. The language that is used promotes a live auction environment and covers what, when, where, and how that auction will be conducted.

The Software will post a picture of item along with description, quantity available, price and/or regular price/discounted price posted on the Site's wall or feed area. Once the time that was indicated for the Auction to begin commences, a picture along with the description, quantity, color, price, and/or regular price/discounted price is published to the sellers on the Site's Wall page.

Potential customers (“Buyers”), within the comment field or commentary area (“the Comments”) of the post, indicates her/her interest in purchasing the item utilizing the predefined wording listed in the auction announcement, not limited, but to include “mine”, “take”, “yes”, “want”, or the like, along with the color, if applicable, and the quantity if applicable. The comment language that indicates a buy or a willingness to purchase by the Buyer, is hereafter referred to as “Key Words”.

The Software processes the Buyer's request in First in First Out (“FIFO”) queue and time sequence order, by processing the Key Words for each posting. Each Key Word that is posted in the Comments that is within the sale time posted, and provided that there is quantity of the wanted item is in stock—that item is considered sold. To process the sale, the Software acknowledges the buyers' indication with a Site comment such as ‘congrats’, ‘congratulation’, ‘sold’, ‘yours’, of the like. The set of acknowledgements are hereafter referred to as “Acks”.

An Ack from the Software triggers a reduction of the quantity equal to the amount requested and Ack'ed in the above steps and immediately is reflected within the Site's wall post by the Software. The Software will repost the item's current sale status (i.e., time left, quantity left, current price) in real time. If or when the reduction equals (=) zero (0) quantity left, a post within the Site's post triggers a sold out for the item.

The Software then processes predefined information that the buyer provides, generates an electronic invoice on behalf of the Seller in a format of its choice. Once the invoice is paid, a message is then sent for fulfillment and item/items are shipped by the Seller. The responsibility of payment and the fulfillment of the order is up to the Buyer and Seller. The Software has no liability in the transaction.

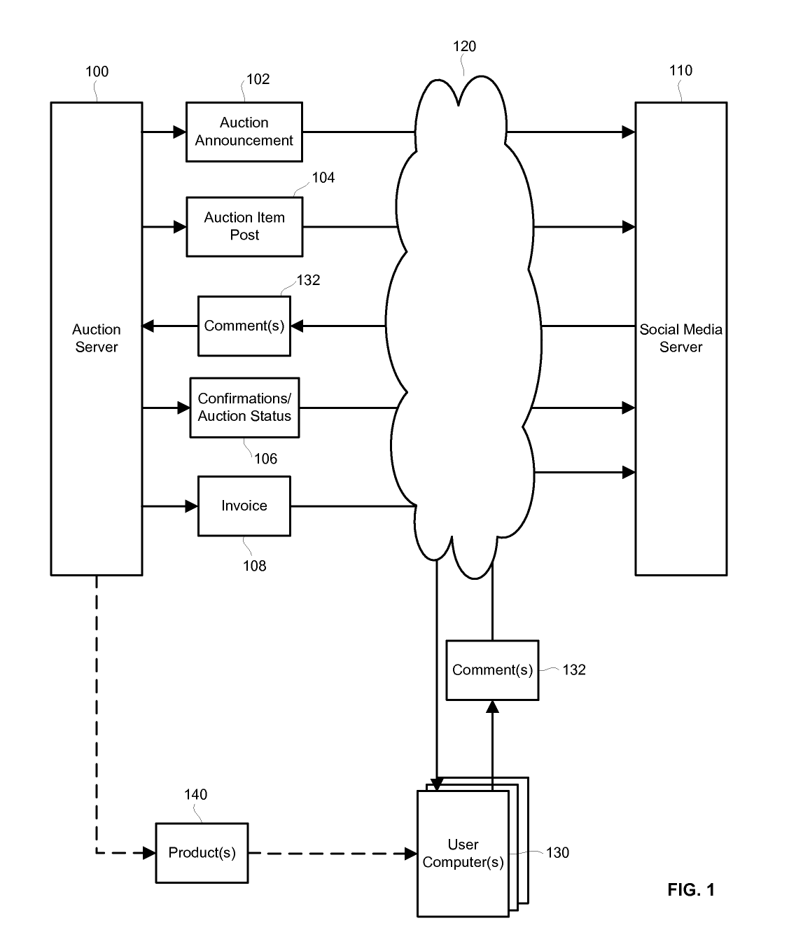

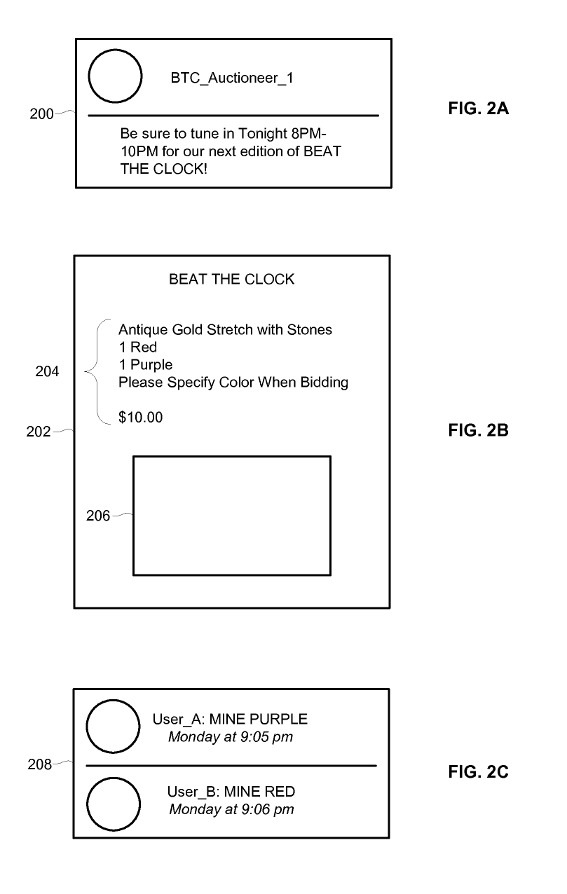

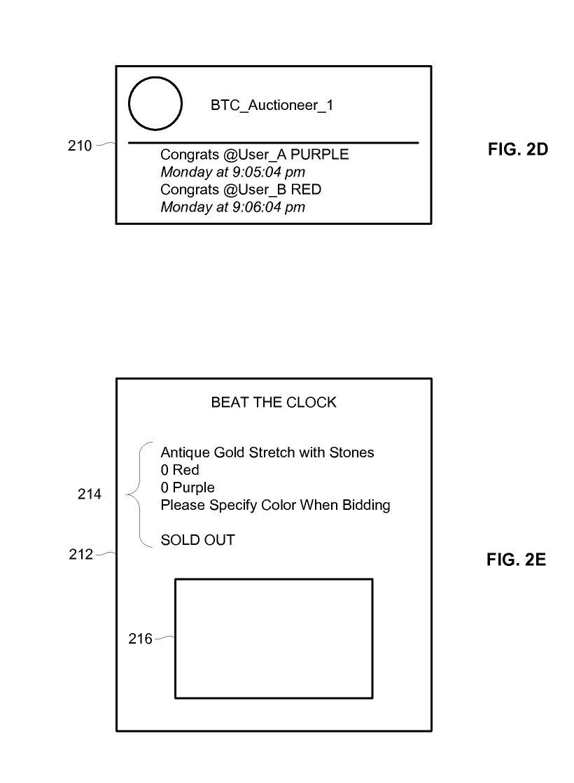

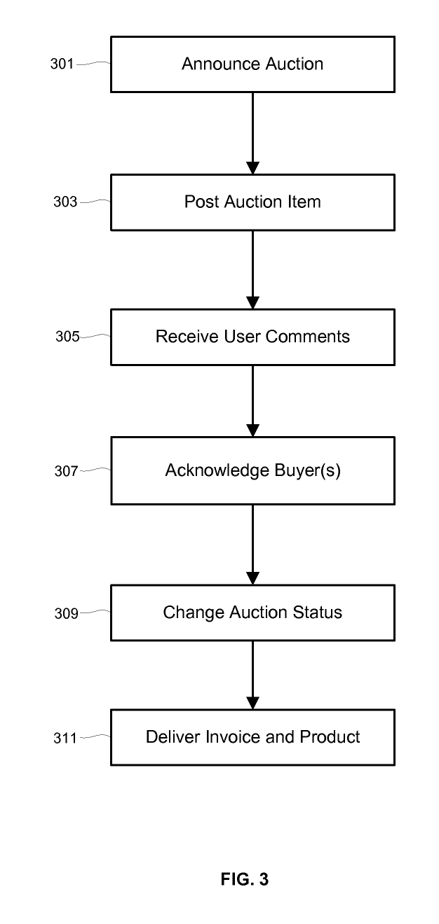

Referring to the figures in detail, and first to FIG. 1, the auctioning system comprises an auction server 100 embodied in computer hardware. The auction server 100 includes a network connection for connecting the server to one or more social media servers 110 (e.g., embodied in computer hardware) through a network 120 (e.g., LAN, WAN, Internet). The auction server 100 comprises a processor or processing unit embodied in computer hardware which, using software executing thereon, generates, advertises and processes at least one auction. In particular, the auction server 100, and more specifically software executing on the processor therein, generates an auction announcement 102. The auction announcement includes information regarding the start time when the auction begins and an end time when the auction finishes. FIG. 2A shows one embodiment of the auction announcement 200. The announcement can further include additional information about how a person can participate in the auction (e.g., including a hyperlink to the auction). The auction server 100 transmits the auction announcement through the network 120 to the social media server 110 to be displayed on the social media platform. For example, upon being transmitted to the social media server, the auction announcement is posted within the seller's profile in the social media platform and/or to the wall of specific users in the social media platform. Alternatively, the auction announcement may be posted generally for broad advertising to a plurality of users of the social media platform. Upon the designated start time, the auction server 100 generates and transmits an auction item post 104 to the social media server 110 for publishing to the potential buyers. An example of the auction item post 202 is shown in FIG. 2B. The auction item post includes information 204 about the product, such as color, quantity available, and price (i.e., regular and/or discounted). Further, an image 206 of the product being auctioned is provided in the auction item post 202.

During the auction, the auction server 100 retrieves, using software executing on the auction server processor, user comments or keywords 132 posted by the potential buyers, via user computers 130, within the social media platforms in response to the auction item post. As previously described, the user comments or keywords represent a buyer's purchase of the product being auctioned or the buyer's interested in purchasing the product. In particular, potential buyers can post keywords 132 as comments or commentary to the auction item post 104. FIG. 2C shows an example of the keywords or comments 208 posted by potential buyers “User_A” and “User_B.” In this example, User_A entered “Mine Purple” as a keyword to indicate that he/she wishes to purchase the product (e.g., jewelry) in purple. Thereafter, User_B posted keyword “Mine Red” to indicate that he/she wants to purchase the product in red.

Whenever comments or keywords 132 are posted by potential buyers, the auction server 100 retrieves them for analysis and processing. When a potential buyer(s), via keywords 132, purchases the product (or a specific quantity of the product), the auction server detects the purchase and immediately transmits a confirmation or an acknowledgement 106 to the buyer on the social media platform, wherein the acknowledgement confirms the purchase. For example, FIG. 2D shows an acknowledgement 210, which confirms that User_A purchased the product in purple and that User_B purchased the product in red as well as reflects the respective purchase times. The acknowledgement 106 may be posted to the seller's wall, the buyer's wall, or both immediately after the purchase. In some embodiments, the auction server 100 also sends an electronic invoice to the buyer's computers 130.

The auction server 100 also analyzes the keywords 132 to update the status of the auction. As shown in FIG. 1, the auction server generates and transmits an auction status 106 to the social media server 110 to reflect the status of the auction. The auction status (FIG. 2E) implements real-time adjustments to show current quantity available and color available for the product being auctioned. It is noted that the transmission of an acknowledgement and the generation/transmission of the auction status can occur simultaneously or near simultaneously.

The actuation server further provides an auction status 106 to the social media server 110 once the product is sold out. FIG. 2E shows an auction status 212 reflecting a sold out product. In particular, information about the products 212 has been adjusted to show that there are zero quantity of the product and provide a “Sold Out” indicator. An image 216 of the product is also provided in the auction status 212. As shown in FIG. 1, upon completion of the sale, the product 140 may be shipped to the successful buyer(s).

The present invention also provides for a method of auctioning a product through one or more social media platforms. Such method includes providing an auction server (and/or software) for generating, advertising and processing at least one auction. As shown in FIG. 1, the method further comprises generating and transmitting an auction announcement to at least one social media server of said social media platform for advertising to potential buyers, said auction announcement providing a start time for when the auction begins and an end time for when the auction ends (step 301); generating and transmitting an auction item post to said social media server for publication to said potential buyers at said start time (step 302); receiving user comments by said potential buyers from said social media server, said user comments representing buyer's purchase and/or interest in purchasing (step 303); processing said user comments to detect a purchase of product by a buyer among said potential buyers and transmit acknowledgments to successful buyers (step 307); and updating in real time a status of said auction item post using said user comments (step 309). In some embodiments, the method further includes the step of sending an invoice to the buyer and/or shipping the product won in the auction (step 311). The method is at least partially implemented with software which automatically executes the steps of the method.

In one embodiment, the acknowledgement step (step 311) further includes delivering an invoice and processing, by said auction server, shipping details for shipping said product.

Although the invention has been described with reference to particular arrangement of parts, features, and the like, these are not intended to exhaust all possible arrangement or features, and indeed many modifications and variations will be ascertainable to those of skill in the art.

What is claimed is:

1. A system for conducting online auctions in one or more social media platforms, comprising:
an auction server having a network connection, said auction server being adapted to connect to at least one social media server of said social media platform through a network;
a processor disposed in said auction server for generating, advertising, and processing at least one auction;
said auction server generates and transmits an auction announcement to said social media server for advertising to potential buyers, said auction announcement providing a start time for when the auction begins and an end time for when the auction ends;
said auction server transmits an auction item post to said social media server for publication to said potential buyers at said start time;
said auction server retrieves from said social media server keywords posted by said potential buyers on said social media platform, said keywords representative of buyer's purchase and/or interest in purchasing;
said auction server detects a purchase of product by a buyer of said potential buyers via said keywords and transmits a purchase confirmation to said buyer; and
said processor analyzes said keywords to update status of auction and adjusts said auction item post in real-time.

2. The system of claim 1, wherein the auction announcement is posted on seller's profile in said social media platform.

3. The system of claim 1, wherein the auction announcement is posted on a plurality of potential buyer's profiles in said social media platform.

4. The system of claim 1, wherein the auction item post is posted on seller's profile in said social media platform.

5. The system of claim 4, wherein the auction item post is posted in a status or new feed of said seller's profile.

6. The system of claim 5, wherein said keywords originate from comment entries posted by said potential buyers in response to said auction item post.

7. The system of claim 1, wherein said auction server processes said keywords in a first-in first-out sequence to determine which of said potential buyers is first to purchase said product.

8. The system of claim 1, wherein said auction server transmits an acknowledgment to said social media server for publication on said social media platform, said acknowledgment indicating the purchase of the product.

9. The system of claim 8, wherein said acknowledgment is posted as a comment entry to said auction item post.

10. The system of claim 1, wherein said auction item post comprises at least one image of the product, at least one purchase price for the product, and a quantity available of the product.

11. The system of claim 10, wherein the at least one purchase price comprises an original price and a discounted price.

12. The system of claim 1, further comprising a storage device accessible by said auction server, said storage device storing information on products to be auctioned.

13. The system of claim 1, wherein the auction server determines the start time and the end time for said auction.

14. A method of auctioning a product through one or more social media platforms, comprising the following steps:
generating and transmitting, via software executing on an auction server, an auction announcement to at least one social media server of said social media platform for advertising to potential buyers, said auction announcement providing a start time for when an auction begins and an end time for when the auction ends;
generating and transmitting an auction item post to said social media server for publication to said potential buyers at said start time;
receiving user comments by said potential buyers from said social media server, said user comments representing one of buyer's purchase or interest in purchasing the product;
processing said user comments to detect a purchase of product by a buyer among said potential buyers;
sending an acknowledgement to said buyer, said acknowledgment confirming buyer's purchase; and
updating in real time a status of said auction item post using said user comments.

15. The method of claim 14, wherein said auctions server processes said user comments in a first-in first-out sequence to determine which of said potential buyers is first to purchase said product.

16. The method of claim 14, further comprising the step of delivering an invoice and processing, by said auction server, shipping details for shipping said product.
